(19) United States
(12) Patent Application Publication
(10) Pub. No.: US 2010/0014743 A1
(43) Pub. Date: Jan. 21, 2010

(54) COMPACT MULTIPASS DOCUMENT PROCESSOR

(76) Inventor: James Michael Spall, Commerce, MI (US)

Correspondence Address: UNISYS CORPORATION, UNISYS WAY, MAIL STATION: E8-114, BLUE BELL, PA, 19424, US

(21) Appl. No.: 12/176,791

(22) Filed: Jul. 21, 2008

(51) Int. Cl. G06K 9/78

(52) U.S. Cl. 382/139

(57) ABSTRACT

An apparatus for capturing data and images from checks and other financial and payment-related documents includes a compact, desktop document processor base unit and a transport stage including a plurality of processing devices and a multipass document track. The transport stage conveys the documents through the multipass document track and past tile plurality of processing devices. The transport stage receives a document from the input slot on the base unit, routes the document multiple consecutive times through the multipass document track, and then directs the document to the output slot on the base unit. The introduction of the multiple pass process may provide sufficient apparent track length for all legally required features for Check 21 in a small footprint. For example, magnetic ink character reading, endorsing, and rear imaging may be performed on separate passes of the document through the document track.

### BACKGROUND OF THE INVENTION

1. Field of the Invention

The invention relates to document processing, and to compact, desktop document processors for capturing data and images from checks and other financial and payment-related documents. The invention further relates to document processors designed for processing documents at a teller window.

2. Background Art

Historically, banks processed large volumes of paper checks in centralized locations, either a central bank or a clearing house. Document processing machines in such locations were large, processing up to 2000 documents per minute. These machines were supported by dedicated, trained operators.

However, centralized processing costs banks typically three days in clearing a document. The “Check Clearing for the 21st Century Act” or the “Check 21 Act” was enacted by Congress to facilitate check truncation by authorizing substitute checks, to foster innovation in the check collection system without mandating receipt of checks in electronic form, and to improve the overall efficiency of the Nation's payments system. The Check 21 legislation has driven the demand for decentralized check imagers and sorters in financial institutions. Check 21 gives equal legal validity to electronic data obtained from documents, and has made it possible for banks to distribute document processing to speed the clearing process. Check 21 has made it advantageous for banks to convert paper checks to electronic data as early as possible.

In the recent past, banks have partially converted paper check information to electronic data. In some cases this partial information was used internally. In other cases two banks would agree on standards for electronic data transfer. In either case, the paper check was still the only legal document for the transaction. Check 21 has standardized these agreements across the banking industry, and given the electronic data legal merit, if the electronic data meet the requirements set forth in Check 21.

When a bank obtained electronic data for internal use, it could accept partial data, since the paper check was always maintained as the legal record of a transaction. To this end several small machines have been produced which only obtain a portion of the data contained on a paper check. Since Check 21 theoretically allows the destruction of paper checks after conversion to electronic data, Check 21 requires all data on the paper check to be recorded. This has required physically larger machines capable of obtaining such a full suite of data

As noted, it is advantageous for banks to convert paper checks to Check 21 valid electronic data as early as possible. That suggests performing the conversion at the teller window. In fact, partial electronic conversion has happened at lie teller window for some time. Typically, only the information on the magnetic ink character recognition (MICR) band is converted. This falls well short of Check 21 requirements. A larger device could be provided for each teller but, beyond the expense of such an arrangement, table space at a teller window is in extremely short supply. Many machines capable of obtaining electronic data acceptable for Check 21 just will not fit the teller window environment.

For the foregoing reasons, there is a need for an improved document processor that is capable of obtaining electronic data acceptable for Check 21, and is suitable for teller window use.

### SUMMARY OF THE INVENTION

It is an object of the invention to provide a compact multipass document processor. The introduction of the multiple pass process may provide sufficient apparent track length for all legally required features for Check 21 in a small footprint.

In one embodiment of the invention, a compact, desktop document processor for use on a counter-top is provided. Embodiments of the invention may address the teller window space problem by obtaining Check 21 acceptable electronic data from paper checks in a device similar in size to the existing readers, or one-third the size of existing Check 21 document processors. Embodiments of the invention introduce a multiple pass process to provide longer apparent track length without increasing the size of the machine.

Beyond the legal requirements, the complete electronic conversion of data from a paper check has certain physical requirements. For example, the complete line must be read before the data therein can be processed to compose a programmable rear endorsement. This implies a track length equal to at least the length of the longest document between the head and the programmable rear endorser. Embodiments of the invention may eliminate the need for a documents length of track between the head and the programmable rear endorsement position by sending the document all the way around the track after reading and endorsing on the second pass.

In another example, the programmable rear endorsement must be imaged as evidence of the transaction. This normally means that the rear image camera would be placed after the programmable rear endorser. While the endorsement can be imaged as it is being printed, programmable endorsing requires an ink jet printer in the current state of the art. Putting an image camera immediately downstream of an ink jet printer is undesirable.

Embodiments of the invention address this proximity issue by rear endorsing the document downstream of the rear image camera Ink is therefore carried away from the camera. The rear endorsement has almost a full lap of the track to dry before passing over, and being imaged by, the rear image camera. The track walls in the vertical band of the rear endorsement could also be recessed to prevent smearing the rear endorsement.

It is appreciated that embodiments of the invention utilize a multiple pass process in a compact, desktop document processor. Embodiments of the invention are useful for many document processing applications, such as counter-top and teller window applications where space is limited, particularly when complete electronic check conversion is required.

### BRIEF DESCRIPTION OF THE DRAWINGS

FIG. 1 illustrates a compact multipass document processor in an embodiment of the invention;

FIG. 2 illustrates a schematic view of the compact multipass document processor; and

FIG. 3 illustrates a top view of the compact multipass document processor.

### DETAILED DESCRIPTION OF TEE PREFERRED EMBODIMENTS

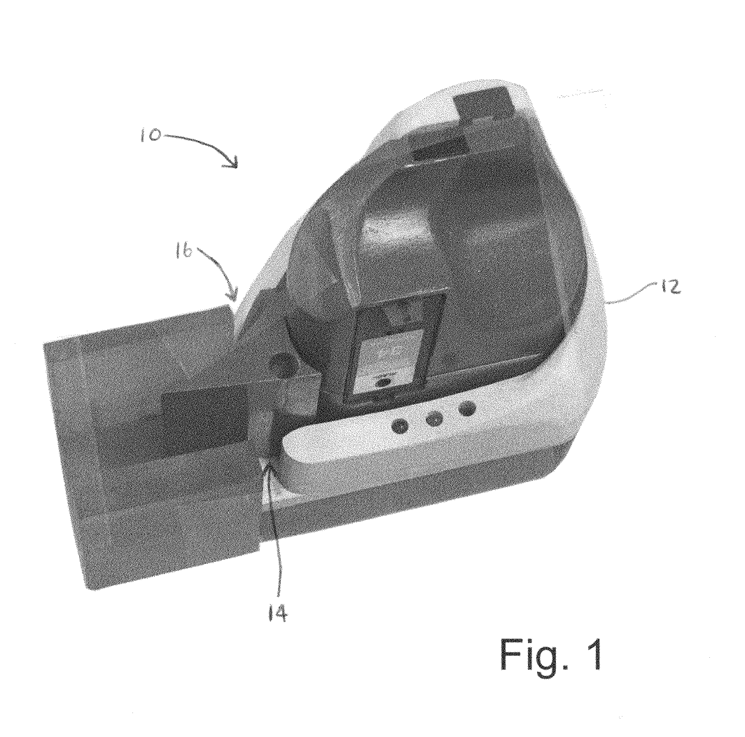

As shown in FIG. 1, a compact, desktop document processor is generally indicated at 10. The apparatus 10 includes base unit 12, and input slot 14 for receiving a check to be processed. The processed check exits at output slot 16. In general, apparatus 10 is used for decentralized document processing applications.

The apparatus 10 may be constructed to perform any number of known document processing actions as appreciated by one of ordinary skill in the art. Suitable electronics and mechanical mechanisms are located within base unit 12. For example, apparatus 10 may perform front and rear image capture, magnetic ink character recognition (MICR) reading, optical character recognition (OCR) reading, endorsing, and/or bar code reading depending on the application. Advantageously, the electronics and mechanical mechanisms required for the document processing actions are provided within base unit 12 as readily understood by one of ordinary skill in the art. The apparatus may be provided with a suitable network connection interface such as Ethernet or Universal Serial Bus (USB).

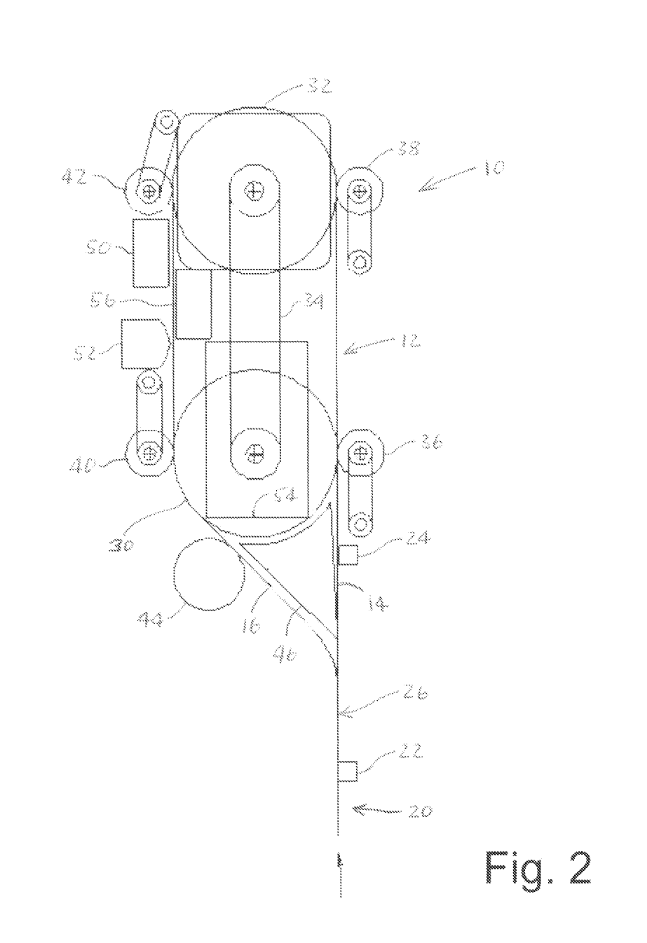

FIG. 2 illustrates a schematic view of the compact multipass document processor in one embodiment.

The apparatus 10 includes a transport stage 20 located within the base unit 12. A first document sensor 22 and a second document sensor 24 are preferably spaced as far apart as possible and as close to the bottom of the track 26 as possible to ensure proper document registration with the bottom of track 26. When the document received at input slot 14 covers both sensors 22 and 24, the document track 26 is energized. This causes first and second drive rollers 30 and 32 connected by belt 34, respectively, for conveying the document through document track 26, to begin to rotate. Transport stage 20 includes the multipass document track 26 and a plurality of processing devices. Transport stage 20 conveys the documents through the multipass document track 26 and past the plurality of processing devices, with the processing devices performing operations on the documents, as further described below.

Upon feeding from input slot 14, the document is captured between first drive roller 30 and pinch roller 36, and is driven forward. The document is then constrained to follow around drive roller 32 between drive roller 32 and pinch roller 38.

As the document passes front image camera 50, which is located along the multipass document track 26, the front image camera 5 0 captures a front image of the passing document. The document then passes magnetic ink character recognition (MICR) device 52 and the MICR data is read off the document.

The document is constrained to follow around drive roller 30 by constraining element 46 and begins a second lap through the document track. That is, constraining element 46 is positioned along the multipass document track 26 for constraining travel of the document, to cause the document to be routed multiple consecutive times through the multipass document track prior to being routed to the output slot 16.

After the trailing edge of the document clears the MICR device 52, the data output from the MICR device 52 is processed to compose the programmable rear endorsement message for endorser 54. That is, MICR device 52 and programmable rear endorser 54 are positioned sufficiently close to each other along the multipass document track 26 such that the MICR device 52 operates during a first pass of the document, the endorser 54 is programmed based on the output of the MICR device 52, and the endorser 54 operates during a subsequent pass of the document through the multipass document track 26.

As the document begins a second lap of the track, the document continues around drive rollers 30 and 32, with the assistance of pinch rollers 36, 38, 40, and 42. As the document nears completion of its second lap, the rear of the document is programmably endorsed by endorser 54.

In the illustrated embodiment, base unit 12 also includes rear image camera 56 located along the multipass document track 26 and positioned upstream of the endorser 54 for capturing a rear image of the document. The rear image camera 56 operates during a pass of the document through the multipass document track 26 that is subsequent to the pass during which the endorser 54 operates. In more detail, as the document nears completion of its second lap, the rear of the document is endorsed by endorse head 54, and the document is constrained by constraining element 46 to follow around drive roller 30 and begin a third lap of the track.

The document continues, again, around driver rollers 30 and 32. The document and the programmable rear endorsement on it pass rear image camera 56 and are rear imaged. After this third lap, the document is ejected from the track 26 after a partial turn around drive roller 30 at the control of constraining element 46. The front of the document is defaced or franked by franker 44 to prevent reentry. The document is routed to output slot 16 for manual removal.

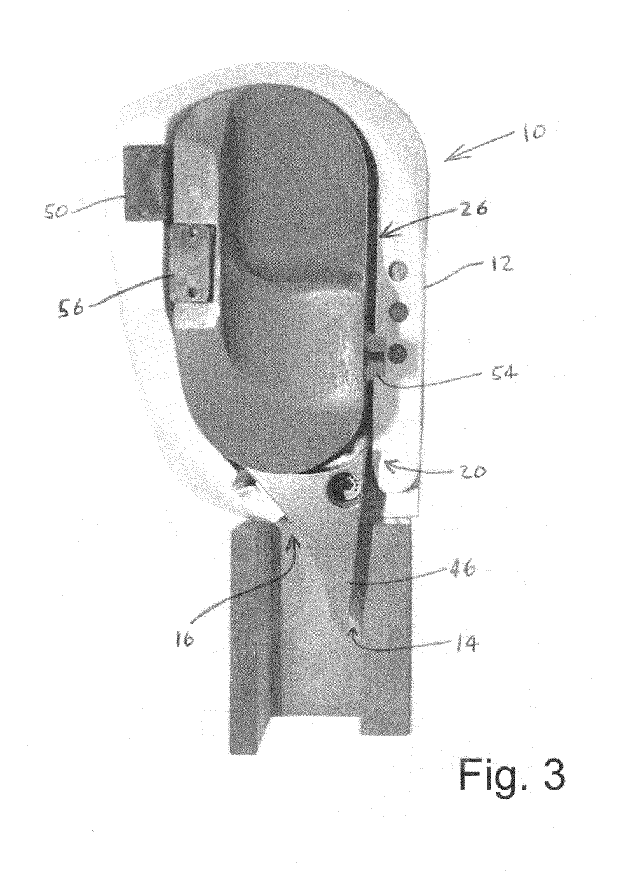

FIG. 3 illustrates a top view of the compact multipass document processor. Similar to FIG. 1, the apparatus 10, base unit 12, input slot 14, and output slot 16 are shown. In addition, the reference numbers used in FIG. 3 are the same as those used in FIG. 2 for the same parts. In FIG. 3, the front image camera 50, rear image camera 56, and a portion of the endorser 54 are all visible. Additional components are contained within base unit 12 and are not visible in this illustration.

It is appreciated that embodiments of the invention need not require the document to reverse direction. This approach is in contrast to an approach which attempts to accomplish a similar result by moving the document back and forth. Put another way, a multipass single direction process, of which one embodiment is shown in FIGS. 1-3, has many advantages. As is appreciated by those of ordinary skill in the art of document processing, a mechanism which moves paper in one direction is far easier to build and far more reliable than a back and forth transport -- no stopping and starting, no reverse edges to catch on, no speed variations, less chance for misalignment.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for capturing data and images from checks and other financial and payment-related documents, the apparatus comprising:
a compact desktop document processor base unit including an input slot for receiving a check to be processed, and including an output slot;
a transport stage located within the base unit, the transport stage including a plurality of processing devices and a multipass document track, the transport stage conveying the documents through the multipass document track and past the plurality of processing devices, the processing devices performing operations on the documents;
wherein the transport stage receives a document from the input slot, routes the document multiple consecutive times through the multipass document track, and then directs the document to the output slot; and
wherein the plurality of processing devices includes a magnetic ink character recognition (MICR) device and a programmable endorser positioned sufficiently close to each other along the multipass document track such that the MICR device operates during a first pass of the document through the multipass document track, the endorser is programmed based on an output of the MICR device, and the endorser operates during a subsequent pass of the document through the multipass document track.

2. The apparatus of claim 1 farther comprising:
a constraining element positioned along the multipass document track for constraining travel of the document to cause the document to be routed multiple consecutive times through the multipass document track prior to being routed to the output slot.

3. The apparatus of claim 2 farther comprising:
a pair of drive rollers for conveying the document through the multipass document track.

4. The apparatus of claim 2 farther comprising:
a pair of sensors at the input slot for detecting the placement of the document in the input slot.

5. The apparatus of claim 2 further comprising:
a front image camera located along the multipass document track, the front image camera capturing a front image of the document.

6. The apparatus of claim 2 further comprising:
a franker located along the multipass document track, the franker defacing the document when the document is being routed to the output slot.

7. The apparatus of claim 2 further comprising:
a rear image camera located along the multipass document track and positioned upstream of the endorser along the multipass document track, the rear image camera capturing a rear image of the document; and
wherein the rear image camera operates during a pass of the document through the multipass document track that is subsequent to the pass during which the endorser operates.

8. The apparatus of claim 7 further comprising:
a pair of drive rollers for conveying the document through the multipass document track.

9. The apparatus of claim 7 further comprising:
a pair of sensors at the input slot for detecting the placement of the document in the input slot.

10. The apparatus of claim 7 further comprising:
a front image camera located along the multipass document track, the front image camera capturing a front image of the document.

11. The apparatus of claim 7 further comprising:
a franker located along the multipass document track, the franker defacing the document when the document is being routed to the output slot.

12. An apparatus for capturing data and images from checks and other financial and payment-related documents, the apparatus comprising:
a compact, desktop document processor base unit including an input slot for receiving a check to be processed, and including an output slot;
a transport stage located within the base unit, the transport stage including a plurality of processing devices and a multipass document track, the transport stage conveying the documents through the multipass document track and past the plurality of processing devices, the processing devices performing operations on the documents;
wherein the transport stage receives a document from the input slot, routes the document multiple consecutive times through the multipass document track, and then directs the document to the output slot; and
wherein the plurality of processing devices includes an endorser and a rear image camera positioned upstream of the endorser along the multipass document track such that the endorser operates during a first pass of the document through the multipass document track, and the rear image camera operates during a subsequent pass of the document through the multipass document track.

13. The apparatus of claim 12 further comprising:
a constraining element positioned along the multipass document track for constraining travel of the document to cause the document to be routed multiple consecutive times through the multipass document track prior to being routed to the output slot.

14. The apparatus of claim 12 further comprising:
a pair of drive rollers for conveying the document through the multipass document track.

15. The apparatus of claim 12 further comprising:
a pair of sensors at the input slot for detecting the placement of the document in the input slot.

16. The apparatus of claim 12 further comprising:
a front image camera located along the multipass document track, the front image camera capturing a front image of the document.

17. The apparatus of claim 12 further comprising:
a franker located along the multipass document track, the franker defacing the document when the document is being routed to the output slot.
